(19) United States
(12) Patent Application Publication
(10) Pub. No.: US 2025/0380029 A1
(43) Pub. Date: Dec. 11, 2025

(54) GENERATING CONTENT RECOMMENDATIONS WITH LANGUAGE MODEL NEURAL NETWORKS USING REASONING OUTPUTS

(71) Applicant: GDM Holding LLC, Mountain View, CA (US)

(72) Inventors: Lichan Hong, Los Altos, CA (US); Adam Wiggen Kraft, Mountain View, CA (US); Xinyang Yi, Sunnyvale, CA (US); Ed Huai-hsin Chi, Palo Alto, CA (US); Anahita Hosseini, Saratoga, CA (US)

(21) Appl. No.: 19/233,973

(22) Filed: Jun. 10, 2025

Related U.S. Application Data
(60) Provisional application No. 63/658,371, filed on Jun. 10, 2024.

(51) Int. Cl. H04N 21/466

(52) U.S. Cl. CPC H04N 21/4666; H04N 21/4668

(57) ABSTRACT

Methods, systems, and apparatuses, including computer programs encoded on computer storage media, for generating reasoning outputs and respective predicted ratings of content items using a language model neural network, training the language model neural network to further improve the quality of reasoning outputs, and generating high quality reasoning outputs for reasoning examples. By processing input sequences that include the interaction history of a particular user, the metadata of a current content item, and sometimes the rating of the current content item, the system can generate predicted ratings, generate candidate training reasoning outputs to train the language model neural network, and generate high quality example reasoning outputs.

### CROSS-REFERENCE TO RELATED APPLICATIONS

This application claims priority of U.S. Provisional Application No. 63/658,371, filed Jun. 10, 2024. The content of the prior application is incorporated herein by reference in its entirety.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a rating prediction system implemented as computer programs on one or more computers in one or more locations that generates reasoning outputs and respective predicted ratings of content items using a language model neural network. This specification also describes how the system can train (“fine-tune”) the language model neural network to further improve the quality of the reasoning outputs and, as a result, the respective predicted ratings.

This specification also describes a reasoning generation system implemented as computer programs on one or more computers in one or more locations that can generate reasoning outputs that accurately explain why a given user submitted a particular rating for a particular content item.

One aspect of the described subject matter is set out in claim 1; another aspect is set out in claim 16.

In some implementations the language model neural network is a so-called large language model neural network (LLM); in some implementations a relatively larger language model neural network is used to train, in particular fine-tune, a smaller language model neural network, e.g., for use in an edge device.

A general problem addressed by the described subject matter is how to obtain good quality ratings (recommendations). A large language model (LLM) can be used as described herein to enhance personalized recommendations, but using an LLM can be computationally intensive, as well as incurring a significant power consumption. Thus the further problem can arise of how to obtain good quality ratings (recommendations) on an edge device such as a mobile phone or laptop computer, which may have limited computational capacity, working memory capacity, or battery capacity. The edge device can have a main processor and a machine learning co-processor, e.g., a co-processor optimized for matrix multiplication. It can then be configured to implement a (the) language on the machine learning co-processor, but the problem still arises.

Some implementations of the described techniques can address this further problem by using a large language model to train a smaller language model, where a model size can be defined by a number of trainable/trained parameters of the model, such as weights.

More particularly this can be achieved by using a method as described above to obtain a training data set that includes the one or more reasoning examples for the selected candidate reasoning outputs (for a current content item). The training data set can also include the rating of the current content item, more particularly the ground truth rating, i.e., the rating of the current content item provided by the particular user after interacting with the current content item.

A rating system, e.g., as previously described or as set out in claim 1 or its dependent claims, but using a smaller language model, can then be trained, more specifically fine-tuned, after pre-training, using the training data set. That is reasoning outputs generated by a larger language model can be collected to serve as training data for fine-tuning a smaller model. Some example results presented later demonstrate the effectiveness of using a larger model to generate reasoning data, enhancing the performance and reasoning abilities of a smaller, fine-tuned model.

The smaller language model is implemented on the edge device, e.g., on or using the machine learning co-processor of the edge device. The main processor can interact with the co-processor to obtain ratings (recommendations), and to obtain the (recommended) current content item for presentation to the particular user. Obtaining the current content item can involve, e.g., downloading the current content item from remote storage onto the edge device, e.g., via a wireless or wired network.

Particular embodiments of the subject matter described in this specification can be implemented so as to realize one or more of the following advantages.

Traditional techniques to generate a task output (e.g., a predicted rating by a particular user for a content item given the user interaction history and metadata of the content item) are generally “black-boxes” in that it is difficult to understand how and why a particular task output is generated.

But recent advances show that language model neural networks can generate reasoning outputs (e.g., natural language explanation of task outputs) along with task outputs (e.g., generating a reasoning output for a solution to an arithmetic word problem), and these reasoning outputs even enhance the performance of the task outputs. Unfortunately, the reliability of generating and using reasoning outputs is limited to tasks where the reasoning has objective criteria for correctness (e.g., arithmetic word problems, formal logical reasoning, causal reasoning, and so on).

For tasks in which the reasoning for a task output does not have objective criteria for correctness and can be personalized, the generation and use of reasoning outputs is difficult. In particular, using reasoning for the task of predicting a rating of a user for a content item to generate the task outputs of a reasoning output and a predicted rating is inherently difficult. This difficulty is because the reasoning output that should accompany a predicted rating does not have an objective criteria for correctness (i.e., there is no “ground truth” reasoning), there are possibly multiple different reasonings that are equally explanatory of the predicted rating, and the reasoning for a predicted rating is personalized for each user. So when reasoning for a task extends beyond objective criteria to encompass subjectivity and personalized user preferences (e.g., predicting a rating of a user for a content item) many challenges are present.

The primary challenges to generate accurate predicted ratings for a user of a content item include: 1) how to generate reasoning outputs that are personalized, 2) how to train a language model to generate and use high quality reasoning outputs when there are multiple possible valid reasonings and no criteria for correctness, 3) how to generate reasoning examples that include reasoning that is truly explanatory given there is not objective criteria for correctness.

This specification describes a system that can address the aforementioned challenges. That is, this specification describes techniques for generating a predicted rating for a current content item and a reasoning output that includes a natural language explanation of the predicted rating. These techniques include using a language model neural network to process an input sequence representing at least an interaction history for the particular user and a metadata for the current content item to generate a predicted rating for the current content item and a reasoning output that includes an explanation of the predicted rating given the interaction history and the metadata.

The interaction history of the user and metadata of the current content item provide personalized context for the language model neural network to generate a reasoning output that is personalized, and the reasoning output guides the language model neural network towards an accurate predicted rating through the process of generating rationale reasoning.

This specification also describes techniques for training the language model neural network to further improve the quality of the reasoning outputs and, as a result, the predicted ratings. These techniques include generating a plurality of candidate training reasoning outputs by processing an input sequence representing at least (i) the training interaction history for a corresponding user and (ii) the training metadata characterizing a training content item using a language model neural network. Then, selecting candidate training reasoning outputs, and generating training examples from these. More specifically, the techniques include generating multiple candidate training reasoning outputs for each set of training interaction history and training metadata characterizing a training content item, and then verifying the quality of each candidate training reasoning output through a process of generating a predicted rating using the candidate training reasoning output and determining it matches the ground truth rating (i.e., self-verifying).

Training the language model neural network using the self-verified selected training reasoning outputs enables the language model neural network to learn high quality reasonings (and potentially multiple possible reasonings when the training data includes multiple reasonings for the same user and content item) that can be used correctly predict the rating of the user for the content item. Therefore, the language model neural network (after training) can generate high quality reasoning outputs to generate accurate predicted ratings for users and content items.

This specification also describes techniques for generating high quality reasoning examples. These generated reasoning examples serve as high quality “reference” examples that can be used to, e.g., evaluate reasoning output quality. These techniques include generating a plurality candidate reasoning outputs by processing an input sequence that represents at least the interaction history for a particular user, the metadata for a current content item, and the rating of the current content item using a language model neural network, and then selecting one or more of the candidate reasoning outputs (e.g., according to whether a predicted rating for the current content item matches the ground truth rating).

By generating a plurality of candidate reasoning outputs using an input sequence that includes the rating for a current content item, then filtering the candidate reasoning outputs, and then selecting candidate reasoning outputs, the described techniques ensure that the selected candidate reasoning outputs are truly explanatory of the ground truth rating.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows a rating prediction system.

FIG. 2 shows a reasoning generation system.

FIG. 3 is a flow diagram of an example process for generating a predicted rating for a current content item and a reasoning output that includes a natural language explanation of the predicted rating.

FIG. 4 is a flow diagram of an example process for training a language model neural network to further improve the quality of the reasoning outputs.

FIG. 5 is a flow diagram of an example process for generating reasoning examples.

FIG. 6 is an example of the performance of the described techniques.

FIG. 7 is an example of the performance of the described techniques.

FIG. 8 is an example of the performance of the described techniques.

### DETAILED DESCRIPTION

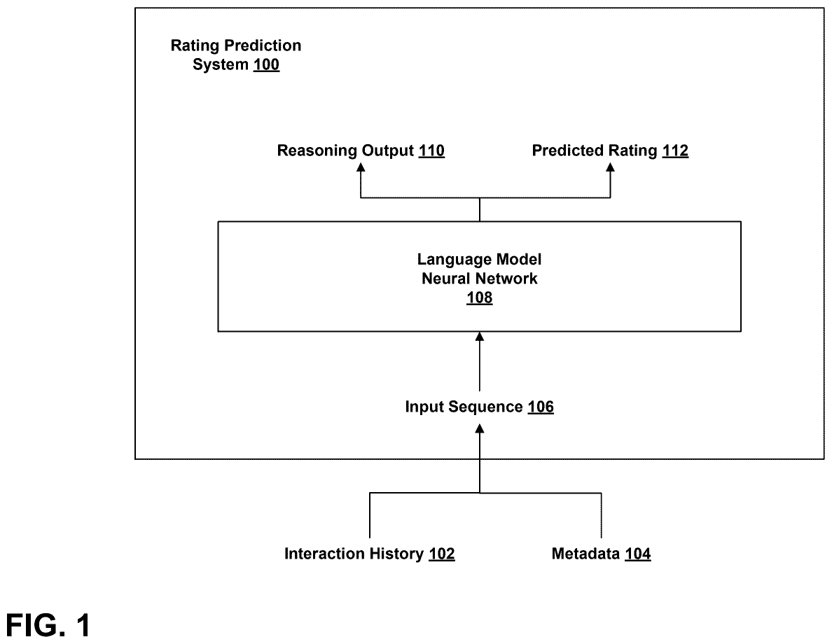

FIG. 1 shows an example rating prediction system 100. The rating prediction system 100 is an example of a system implemented as computer programs on one or more computers in one or more locations, in which the systems, components, and techniques described below can be implemented.

The rating prediction system 100 predicts ratings of content items using a language model neural network 108. That is, the system 100 uses a language model neural network 108 to predict a rating 112 that would be provided by a particular user if the particular user interacts with a current content item given (i) an interaction history 102 for the particular user and (ii) metadata 104 characterizing the current content item.

The content item can be any item that is intended for a user to possess, process, or interact with and has value to the user. For example, the content item can be a video that a user views (i.e., processes) and manipulates through playback options (i.e., interacts with) for entertainment or educational purposes (i.e., has value to the user). As another example, the content item can be an e-commerce product such as shoes that a user digitally orders, receives, and then wears (i.e., possesses and interacts with) and that the user enjoys because the shoes provide the utility of protecting their feet (i.e., has value to the user). Generally, the higher the rating of content item the higher the value of the content item is to the user.

One use of the system 100 is to determine whether to recommend content items to a user. For example, if a user is seeking a video that teaches how to repair drywall by entering a keyword search on a smartphone, the system 100 can use generated predicted ratings for multiple videos with metadata that includes the user provided keywords and determines to recommend the user the video with the respective highest predicted rating (i.e., the video that is predicted to have the highest value to the user). In response to determining to recommend content item to a user, optionally, the system can provide the content item to the user, e.g., through automatic video playback on a smartphone.

More specifically, to predicts ratings of content items, the system 100 causes the language model neural network 108 to generate, in addition to the predicted rating 112 for the current content item, a reasoning output 110 that includes a natural language explanation of the predicted rating 112 given the interaction history 102 and the metadata 104.

Generating a reasoning output 110 in addition to the predicted rating 112 significantly improves the accuracy of the predicted rating 112, i.e., relative to predicting only the predicted rating 112 without a corresponding reasoning output 110. The improvement is generally because the system generates the reasoning output 110 first, and the generating of a reasoning output 110 (e.g., a step-by-step explanation) guides the language model neural network 108 toward a more accurate predicted rating 112.

A “natural language” output, e.g., a natural language explanation, is an output in a natural language, e.g., an explanation in a natural language. Natural language is any language that has evolved naturally in humans through use and repetition that is not a constructed language (e.g., a computer programming language, e.g., Python, C, C++, Java, and so on) or a formal language (e.g., a logic system, e.g., formal proof language in mathematics or philosophy).

In particular, to generate a reasoning output 110 and predicted rating 112 for a current content item, the system 100 obtains an interaction history 102 for a particular user.

The content item can be any appropriate type of content item, e.g., a video, an electronic book, a software application, a news article, a web page, a music content item (e.g., a song) a web page or other resource describing a product, and so on.

The interaction history 102 can be any appropriate information related to content items that the particular user has interacted with in the past. For example, the interaction history 102 can include metadata for each of one or more historical content items that have been interacted with by the particular user.

Metadata generally includes any information that describes the content item, e.g., title, description, keywords, creation date, author, seller, size, topics, text, image(s), audio, video(s), and so on. For example, given a content item of a video, the metadata can include video title, video description, video length, video public view count, video recording date, video upload date, video frames, video thumbnail, and so on. As another example, given a content item of an e-commerce product, the metadata can include, the e-commerce product name, description, average rating, seller, images of the product, video (e.g., video demonstration of product use), and so on. Metadata can also include information generated by the user interacting with the historical content items, e.g., clicks, view, selecting the ‘like’ button, and so on.

The system 100 then obtains metadata 104 characterizing the current content item. The metadata 104 characterizing the current content item can be any appropriate information related to the content item as described above.

After obtaining the interaction history 102 and metadata 104, the system 100 processes an input sequence 106 representing at least the interaction history 102 for the particular user and the metadata for the current content item using a language model neural network 108 to generate an output. The generated output includes (i) the predicted rating 112 for the current content item that is a prediction of a rating provided by the particular user after interacting with the current content item and (ii) the reasoning output 110 that includes a natural language explanation of the predicted rating given the interaction history 102 and the metadata 104.

For example, the input sequence 106 can include natural language instructions for the language model 108 to generate reasoning (i.e., the reasoning output 110) based on the interaction history 102 and the metadata 104 such as “what information can you infer about the user's preferences and how they will rate the <content item> given <metadata 104> and <interaction history 102>”. Also, for this example, the instructions of the input sequence 106 can include a command to predict a numerical rating (i.e., generate the predicted rating 112) for the content item given the reasoning 110 such as “based on the information inferred about the user's preferences and how they will rate the <content item> predict the user's rating of the <content item>”.

The language model neural network 108 can be any neural network that can process the input sequence 106 and generate the predicted rating 112 and reasoning output 110.

For example, the input sequence 106 can be a sequence of tokens that represent the interaction history 102 and metadata 104, and the language model neural network 108 can be an auto-regressive neural network that generates an output sequence (also a sequence of tokens) that represents the predicted rating 112 and reasoning output 110.

In particular, to generate a particular token at a particular position within an output sequence, the language model neural network 108 can process the input sequence 106 to generate a score distribution (e.g., a probability distribution) that assigns a respective score, e.g., a respective probability, to each token in the vocabulary of tokens. The language model neural network 108 can then select, as the particular token, a token from the vocabulary using the score distribution. For example, the neural network 108 can greedily select the highest-scoring token or can sample, e.g., using nucleus sampling or another sampling technique, a token from the distribution.

For example, the neural network 108 can be an auto-regressive attention neural network that includes (i) a plurality of attention blocks that each apply a self-attention operation and (ii) an output subnetwork that processes an output of the last attention block to generate the score distribution.

In this example, the neural network 108 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

More specifically, the neural network 108 includes plurality of layers that include a plurality of attention layers.

Each attention layer receives a respective hidden state for each of the input positions and updates the respective hidden states for each of the input positions by applying an attention mechanism to the respective hidden states.

Further details of the system processing the input sequence 106 using the language model neural network 108 to generate the predicted rating 112 and reasoning output 110 are described below.

In some implementations, the system 100 can train (“fine-tune”) the language model neural network 108 to further improve the quality of the reasoning outputs 110 and, as a result, the predicted ratings 112.

For example, the system 100 can train the language model neural network 108 using reasoning outputs generated by another language model neural network that accurately reflect the diverse set of possible explanations that a given user may have for providing a given rating for a given content item.

After the system generates the predicted rating 112, in some cases, the system 100 can determine whether to recommend the current content item to the particular user using the predicted rating 112.

For example, the system 100 can predict the rating 112 as part of making a content item recommendation for the user. The system 100 can generate the content item recommendation in any appropriate context.

For example, the system 100 can generate content recommendations during a conversation between the user and one or more other entities, e.g., another user or a chatbot or both.

As another example, the system 100 can generate content recommendations in response to search queries submitted by the user to a search engine, e.g., an Internet search engine that searches web pages on the Internet, an image search engine that searches a repository of images, a video search engine that searches a repository of videos, an app store search engine that searches a repository of software applications that are available for download, an electronic book store search engine that searches a repository of electronic books, and so on.

Generally, after the system 100 generates a recommendation of a given content item, the system 100 or another system presents the recommended content item to the user, e.g., on a user device of the user. For example, the system 100 can provide the content item for presentation to a user or provide a search result that identifies the content item and that, when selected by a user, causes the content item to be presented with by the user.

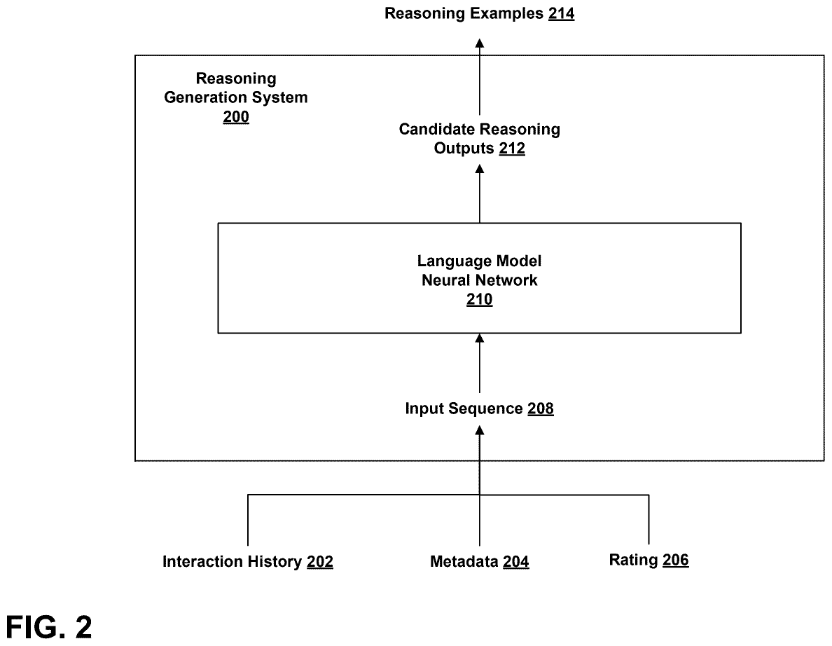

In some cases, prior to using the language model neural network 108 to generate predicted ratings and reasoning outputs, the rating prediction system 100 or another training system trains, e.g., fine-tunes starting from a pre-trained model, the language model neural network 108 to generate a personalized high quality reasoning output 110 and a predicted rating 112. However, this training requires training examples that include high quality candidate reasoning outputs. One example of a system that can generate such outputs is described below with reference to FIG. 2.

FIG. 2 shows an example reasoning generation system 200. The reasoning generation system 200 is an example of a system implemented as computer programs on one or more computers in one or more locations, in which the systems, components, and techniques described below can be implemented.

More specifically, the system 200 can generate reasoning examples 214 that include reasoning outputs 212 that accurately explain why a given user submitted a particular rating for a particular content item. These generated reasoning examples 214 can then be included in a reference data set that includes reasoning outputs 212 that accurately reflect the diverse set of possible explanations that a given user may have for providing a given rating for a given content item, i.e., that includes high-quality reference reasoning outputs despite content recommendation being a very subjective domain. This reference data set can then be used by the system 200 or by another system for any of a variety of purposes, e.g., can be used to evaluate reasoning outputs generated by a neural network or to train a neural network to generate improved reasoning outputs.

In particular, to generate reasoning examples 214, the system 200 obtains an interaction history 202 for a particular user, metadata 204 characterizing a current content item, and a rating 206 of the current content item provided by the particular user after interacting with the current content item.

The system 200 then processes an input sequence 208 representing at least the interaction history 202 for the particular user, the metadata 204 for the current content item, and the rating 206 of the current content item using a language model neural network 210 to generate a plurality of candidate reasoning outputs 212 that each include a respective natural language explanation of why the particular user assigned the rating to the current content item.

Generally, the input sequence 208 includes natural language text that includes instructions to generate the explanation of why the particular user assigned the rating 206 to the current content item given the interaction history 202 and the metadata 204.

It will be understood that the language model neural network 210, while in some cases being distinct from the language model neural network 108 above, can have similar architectures and uses as the language model neural network 108 described above.

Then, after generating a plurality of candidate reasoning outputs 212, the system 200 selects one or more of the candidate reasoning outputs 212 and, for each selected candidate reasoning output 212, generates a reasoning example 214. The reasoning example 214 includes the interaction history 202 for a particular user, the metadata 204 characterizing the current content item, the rating 206 of the current content item, and the selected candidate reasoning output 212.

To select the one or more of the candidate reasoning outputs 212, the system 200 can using any of a variety of techniques. For example, the system 200 can select all the candidate reasoning outputs 212.

As another example, the system 200 can select a random subset of the candidate reasoning outputs 212.

As another example, the system 200 can select candidate reasoning outputs that satisfy criteria. As a particular example, the system 200 can select a candidate reasoning output 212 if using a language model neural network (e.g., the language model neural network 210 or another language model neural network) to process an input sequence that includes the candidate reasoning output results in a correct predicted rating for the content item for the particular user.

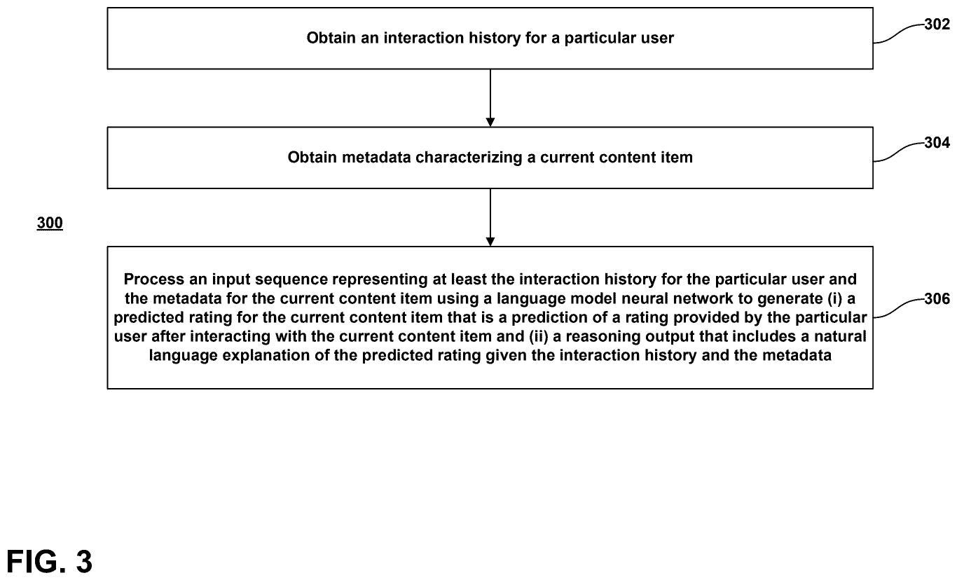

FIG. 3 is a flow diagram of an example process 300 for generating a predicted rating for a current content item and a reasoning output that includes a natural language explanation of the predicted rating. For convenience, the process 300 will be described as being performed by a system of one or more computers located in one or more locations. For example, a rating prediction system, e.g., the rating prediction system 100 of FIG. 1, appropriately programmed in accordance with this specification, can perform the process 300.

The system obtains an interaction history for a particular user (step 302).

In some cases, the interaction history for the particular user includes respective historical metadata for each of one or more historical content items that have been interacted with by the particular user.

As described above, metadata generally includes any information that describes a content item, e.g., title, description, keywords, creation date, author, seller, size, topics, text, image(s), audio, video(s), and so on. Metadata can also include information generated by the particular user interacting with the content item, e.g., clicks, view, selecting the ‘like’ button, and so on. A historical content item is a content item that a user has interacted with prior to the system receiving the interaction history. Therefore, historical metadata is the metadata for a historical content item.

Some examples of historical metadata for historical content items follow.

For example, historical metadata for a historical content item can include interaction data of the user interacting with the historical content items. That is, historical metadata for a historical content item can include information generated by the user interacting with the historical content items.

For example, the interaction data can include data of user-initiated events.

As a particular example, given a historical content item that is a video, the historical metadata can include “liking” the video (i.e., user-initiated event of expressing a preference for the content item, i.e., expressing preference for the video through selecting a “like” button, “clicking” on the video (i.e., user-initiated event of selecting the content item, i.e., selecting the video), or “completing viewing” of the video (i.e., user-initiated event of completing processing of the content item, i.e., finish watching a video).

As another example, given a historical content item that is an e-commerce product (e.g., shoes for sale on a website), the historical metadata can include “adding to a wish list” (i.e., the user initiated event of expressing interest in the content item, i.e., the user marking the e-commerce product to be possibly purchased at a later time), “zooming in on an image of the product” (i.e., the user initiated event of inspecting the content item, i.e., the user inspecting more visual data of the e-commerce product), “toggling product options” (i.e., the user initiated event of configuring the content item, i.e., the user selecting options for the e-commerce product, e.g., selecting shoe size and color for an e-commerce product that is a pair of shoes).

In some cases, the interaction history for the particular user includes, for each of the one or more historical content items, a respective historical rating for the historical content item provided by the particular user after interacting with the historical content item.

A rating for a content item is a score on a defined scale indicating user approval of the content item (with higher rating indicating greater approval). So, a historical rating for a historical content item is rating of a historical content item.

An example rating scale can be 1 through 5 in increments of 1 so that ratings can be 1, 2, 3, 4, or 5. As another example rating scale can be 1 through 10 in increments of 1 so that ratings can be 1, 2, 3, 4, 5, 6, 7, 8, 9, or 10.

For example, given a historical content item that is a video (e.g., a movie on a video streaming website) viewed by the particular user, the historical metadata for the video can include a “ten-star rating” (i.e., a score on a ten point scale that occur in increments of one) provided by the particular user after viewing the video.

As another example, given a historical content item that is an e-commerce product (e.g., shoes for sale on a website) purchased by the particular user, the historical metadata can include “user rating” of the e-commerce product (e.g., rating on a “five-point” scale) provided by the particular user after receiving and using the e-commerce product.

Further in some cases, the interaction history for the particular user includes, for each of the one or more historical content items, a respective natural language review of the historical content item provided by the particular user after interacting with the historical content item.

A review is any expression about a content item. Examples of expressions include opinion of utility, enjoyment, impression, satisfaction, comments, and so on. Also, as described above, natural language is any language that has evolved naturally in humans through use and repetition that is not a constructed language (e.g., a computer programming language) or a formal language (e.g., a logic system). So, a natural language review is any expression by a user about a content item through natural language.

For example, given a historical content item that is a video (e.g., an uploaded video on a video sharing platform) viewed by the particular user the natural language review can be the particular user's comments on the uploaded video expressing enjoyment watching the video. For example, for a video that the user found funny, the particular user can comment saying “that cat playing the piano is the funniest cat on the planet!”.

As another example, given a historical content item that is an e-commerce product (e.g., shoes for sale on a website), the natural language review can be a “customer written review” of the e-commerce product (i.e., a natural language user review of the e-commerce product). For example, for an e-commerce product that is a pair of shoes, a user can write a review that includes the statement “These shoes are the most comfortable shoes I have ever worn. They are great for going on hikes and standing all day.”

The system obtains metadata characterizing a current content item (step 304). As described above, the metadata characterizing a current content item can be any information relevant to the current content item. For example, the metadata of a content item can include title, description, category, brand, price, text, audio, image(s), video(s), and so on.

As a particular example, given a content item that is a video, the metadata can include title, duration, file type, creation date, resolution, frame rate, keywords associated with the video, name of video creator, and so on.

As another particular example, given a content item that is an e-commerce product, the metadata can include product id, product name, description, category, brand, price, stock quantity, product specification, images of the product, video of the product, keywords associated with product, estimated delivery time, seller information, average customer rating of product, and so on.

The system processes an input sequence representing at least the interaction history for the particular user and the metadata for the current content item using a language model neural network to generate (i) a predicted rating for the current content item that is a prediction of a rating provided by the particular user after interacting with the current content item and (ii) a reasoning output that includes a natural language explanation of the predicted rating given the interaction history and the metadata (step 306).

As described above, the interaction history and the metadata can include any type of data (e.g., natural language text data, audio data, image data, video data, any combination of these data, and so on) and, generally, can be represented as an input sequence, e.g., a sequence of natural language text, image pixels or patches, video frames, video frame patches, audio waveform time windows, spectrogram amplitude frequency-time windows, any combination of these elements, and so on. The system can represent the input sequence as a sequence of tokens, e.g., sequence of text tokens, e.g., words, word pieces, bytes, characters, numbers, punctuation, or other text symbols and tokens representing other types of data, e.g., image data, video data, audio data, and so on. Thus, the language model neural network is not limited to processing of text only.

The system can generate a sequence of tokens for the interaction history and the metadata by mapping their data to a sequence of tokens.

For example, if the interaction history and the metadata include natural language text data, then the system can, e.g., map each character, word, or sub-word of the natural language text representation to a corresponding token by applying a text tokenizer to the input text. For example, the system can apply the Byte-Pair Encoding (BPE), WordPiece, or SentencePiece tokenizers to divide the natural language text data into tokens from a vocabulary.

As another example, if the interaction history and the metadata includes audio data, then the system can, e.g., convert the audio into a spectrogram and map segments (i.e., frequency, time patches of the spectrogram) to corresponding tokens, e.g., by applying an audio encoder neural network, e.g., using w2v-BERT model as described in arXiv:2108.06209.

As another example, if the interaction history and the metadata include image data, then the system can, e.g., divide each image into patches or pixels and map each patch or pixel to a corresponding token, e.g., by applying an image encoder neural network to the patch embeddings, e.g., using the pre-trained Align encoder (as described in arXiv:2102.05918) or the pre-trained CoCa encoder (as described in arXiv:2205.01917).

As another example, if the interaction history and the metadata include video, then the system can, e.g., divide each video into a sequence of images and divide each image into patches or pixels and map each patch or pixel to a corresponding token. Alternatively, a token can represent a spatio-temporal portion of the video, e.g., by applying a video encoder neural network, e.g., using the ViViT encoder applied to video frames as described in arXiv:2103.15691.

In some cases, the input sequence includes a natural language description of the interaction history and a natural language description of the metadata for the current content item.

For example, if the content item were an e-commerce product or video the input sequence can include the representation of the following example interaction history for a particular user and a metadata for the current content item:

“### Past User History: ###
{Product / Video (Movies and TV)} Title: {title}
Brand: {brand}
Categories: {categories}
Description: {description}
Item Price: {price}
User Rating: {userRating}
User Review: {reviewText}
...
### New Item Information: ###
New {Product / Video (Movies and TV)}
{Product / Video (Movies and TV)} Title: {title}
Brand: {brand}
Categories: {categories}
Description: {description}
Item Price: {price}”,

where the curly bracket terms represent place holders for the data included in the interaction history (i.e., the terms between “###Past User History: ###” and before “###New Item Information: ###” represent a first historical content item interaction history) and the natural language adjacent to each term is a natural language description of the interaction history (e.g., “Item Price” in “Item Price: {price}” is a natural language description of the interaction history data “{price}”). The curly bracket terms also represent place holders for the data included in the metadata characterizing the current content item follow (i.e., curly bracket terms after the line “###New Item Information: ###”) and the natural language adjacent to these terms are natural language description of the metadata (e.g., “Brand” in “Brand: {brand}” is a natural language description of the metadata “{brand}”).

In some cases, the input sequence further includes a zero-shot prompt. Generally, a zero-shot prompt is text that represents instructions to perform a task that the language model neural network has not been explicitly trained to do. Also, a zero-shot prompt generally does not include task input-task output examples for that specific task.

An example zero-shot prompt can be “predict a numerical rating for {product/video (movies and tv)}” because the prompt, after being processed by a language model neural network as an input sequence, will result in a task output (i.e., predicted rating) without the language model neural network having been explicitly previously trained to do so, and without providing the language model neural network with task input-task output examples.

Further in some cases, the zero-shot prompt includes a natural language task description that includes a natural language instruction to generate the predicted rating and the reasoning output. For example, a zero-shot prompt can include instructions for how to perform a task given a task input.

As a particular example, given a content item that is an e-commerce product or video, the input sequence can include the representation of the following zero-shot prompt:

“Here is information about a user and a new {product /
video (movies and tv)} being recommended to the user.
For the user, we have the user's past item information history
and the user's corresponding ratings. User ratings range from
1 to 5, where 1 is the lowest and 5 is the highest. For the new
item being recommended, we have the item information.
### Past User History: ###
{Product / Video (Movies and TV)} Title: {title}
Brand: {brand}
Categories: {categories}
Description: {description}
Item Price: {price}
User Rating: {userRating}
User Review: {reviewText}
...
### New Item Information: ###
New {Product / Video (Movies and TV)}
{Product / Video (Movies and TV)} Title: {title}
Brand: {brand}
Categories: {categories}
Description: {description}
Item Price: {price}
######
Given the user's past {purchase / watch} history and the
new item information, what information can you infer about
the user's preferences and how they will rate the new
{product / video (movies and tv)} ?
Your reasoning explanation should be based on any
commonalities in the user history items and inferred user
tastes or preferences.
After your reasoning, predict a numerical rating.
Please follow the format below:
### Reason ###
Write your reasoning explanation here. You can have line
breaks.
### Rating ###
Give a single numerical rating, e.g., 1”,

The above natural language input sequence is a natural language task description that includes a natural language instruction to generate the predicted rating (e.g., “After your reasoning, predict a numerical rating.”) and the reasoning output (e.g., “Write your reasoning explanation here. You can have line breaks.”).

In some cases, the input sequence further includes a few-shot prompt. Generally, a few-shot prompt is text that represents one or more task input-task output examples for the task.

As a particular example, given a content item, the input sequence can include the representation of the following multi-shot prompt:

```
“### Example 1 ###
  ### Past User History: ### ...
  ### New Item Information: ### ...
  ### Reason ### ...
  ### Rating ### ...
### Example 2 ###
  ### Past User History: ### ...
  ### New Item Information: ### ...
  ### Reason ### ...
  ### Rating ### ...
  ...”,
```

where the headings “###Example 1 ###”, “###Example 2 ###” delineate the task input-task output examples (i.e., the task input of user interaction history and new item information, and the task output of reasoning output and predicted rating) and for brevity details between the headings “###Past User History: ### . . . ###New Item Information: ### . . . ###Reason ### . . . ###Rating ### . . . ” are omitted and represented with “ . . . ”.

The language model neural network can have any of a variety of neural network architectures. That is, the language model neural network can have any appropriate architecture in any appropriate configuration such that the language model neural network can process an input sequence to generate a predicted rating and a reasoning for the predicted rating, including fully connected layers, convolutional layers, recurrent layers, attention-based layers, and so on, as is appropriate.

Generally, the language model neural network generates the predicted rating and the reasoning for the predicted rating as part of an output sequence (i.e., a sequence of output tokens). For example, the language model neural network can auto-regressively generate an output sequence of tokens. More specifically, the system uses the language model neural network to generate each token in the output sequence conditioned on a current input sequence that includes any tokens that precede the particular token in the output sequence, i.e., tokens that have already been generated for any previous positions in the output sequence that precede the particular position of the particular token.

In particular, to generate a particular token at a particular position within an output sequence, the system can use the language model neural network to process the current input sequence to generate a score distribution (e.g., a probability distribution) that assigns a respective score, e.g., a respective probability, to each token in the vocabulary of tokens. The system can then select, as the particular token, a token from the vocabulary using the score distribution. For example, the system can greedily select the highest-scoring token or can sample, e.g., using nucleus sampling or another sampling technique, a token from the distribution.

Given the context of generating a predicted rating and reasoning output for a content item that is a movie, an example output sequence that includes a predicted rating for the current content item and a reasoning output that includes a natural language explanation of the predicted rating follows:

“### Reason ###
The user has a history of watching action movies,
especially those with a sci-fi or fantasy element. The new
video is an action with a space theme, so it is likely to
appeal to the user.
### Rating ###
5”.

The above example output sequence contains the predicted rating (i.e., ‘5’) and the reasoning output (i.e., “The user has a history of watching action movies, especially those with a sci-fi or fantasy element. The new video is an action with a space theme, so it is likely to appeal to the user.”) surround by additional natural language text (i.e., “###Reason ###” and “###Rating ###”).

In some cases, prior to using the language model neural network to process an input sequence to generate a predicted rating and a reasoning output, the system (or another system) trains the language model neural network. That is, the system (or another system) trains the language model neural network on training data that includes a plurality of training examples, where each training example includes (i) a training interaction history for a corresponding user, (ii) training metadata characterizing a training content item, (iii) a target rating for the training content item, and (iv) a training reasoning output.

In some cases, the language model neural network has been pre-trained prior to being trained on the training data.

For example, the language model neural network can be a pre-trained language model neural network (e.g., pre-trained on a next-token prediction task or masked-token prediction task for a variety of token sequences associated with a variety of domains, e.g., sequences representing bodies of texts found in websites, articles, books, essays, etc., or sequences representing question and answering, multilanguage question and answering, language translation, reasoning, mathematical reasoning, computer programs, and so on). Some examples of pre-trained language model neural networks can include those belonging to the Gemini, Gemma, or PaLM 2 families of neural networks.

In some cases, the training reasoning output in each of the training examples has been generated using another language model neural network. It will be understood that the other language model neural network, while in some cases being distinct from the language model neural network, can have similar architectures and uses as the language model neural network, and therefore, can have any of a variety of neural network architectures, including fully connected layers, convolutional layers, recurrent layers, attention-based layers, and so on, as is appropriate.

Further in some cases, the other language model neural network is a larger neural network than the language model neural network. The reference to “larger” with respect to a neural network can refer to higher latency to process an input sequence, higher memory footprint associate with the neural network, e.g., more parameters included in the neural network (e.g., more layer blocks, more layers per layer block, more neurons per layer, etc.), and so on. For example, the other language model neural network can be a larger, more capable language model that is not practical for generating real-time rating predictions and reasonings outputs (potentially due to the latency cost of processing an input sequence to generate these outputs using the larger language model neural network).

When the language model neural network is smaller than the other language model neural network, it can be advantageous to train the language model neural network on the reasoning outputs of the other language model neural network. That is, given the above describe size relationship between the language model and the other language model, it is advantageous that the language model neural network (after training using reasoning outputs of the other language model neural network) can mimic the performance of the other language model neural network while being significantly less costly to operate (e.g., lower latency for processing an input sequence) because it is smaller.

In some implementations, to generate the training reasoning output, for each training example, the system processes an input sequence representing at least (i) the training interaction history for the corresponding user and (ii) the training metadata characterizing a training content item using the other language model neural network to generate a plurality of candidate training reasoning outputs. Then, the system selects one or more of the candidate training reasoning outputs to be included in respective training examples.

For example, to generate a plurality of candidate training reasoning outputs for a training example, the system can use the other language model neural network to process an input sequence that represents the training interaction history and the training metadata of the training example but also includes natural language instructions to generate a predicted rating along with multiple different possible reasonings for the predicted rating. As a particular example of the input sequence, the input sequence can be “Given a user with interaction history <training interaction history> predict that user's rating of <content item> with metadata <training metadata>. Then, generate an enumerated list of different but plausible reasonings of why the user might assign that rating to the <content item>.” An example output sequence to this example input sequence that includes candidate training reasoning outputs can be “Predicted user rating of <content item> is <predicted rating>. Below is an enumerated list of reasonings that the user may have for assigning that rating \n 1)<first candidate training reasoning output>, 2)<second candidate training reasoning output> < . . . >”

As another example, to generate a plurality of candidate training reasoning outputs for a training example, the system can repeatedly process an input sequence that represents the training interaction history and the training metadata of the training example to generate multiple output sequences (which each include a respective candidate training reasoning output). As a particular example, the system can process an input sequence such as “Given a user with interaction history <training interaction history> predict that user's rating of <content item> with metadata <training metadata>. Then, generate a plausible reasoning of why the user might assign that rating to the <content item>.” repeatedly to generate multiple output sequences.

In order for the output sequences to be different from each other, the system in some cases, for each output sequence, samples tokens for each output position of the output sequence proportionately to the scores assigned to the tokens of the vocabulary by the language model neural network. As a result, the plurality of output sequences collectively include a plurality of candidate training reasoning outputs.

Further in some cases, the token sampling for each output position for the multiple output sequences can be done according to modified scores assigned to the tokens. That is, the system can repeatedly process the input sequence to generate multiple output sequences and, for each output sequence, sample tokens for each output position of the output sequence proportionately to modified scores assigned to the tokens of the vocabulary by the language model neural network. For example, the scores assigned to the tokens of the vocabulary can be modified using a temperature parameter τ. For example, the temperature τ can modify the probability of selecting token vₖ as

$${p}^{′} ( {v}_{k} ) = \frac{{e}^{p ( {v}_{k} ) / τ}}{{\sum }_{i} {e}^{p ( {v}_{i} ) / τ}}$$

where p′(vₖ) represents the temperature modified probability of selecting token vₖ, p(vₖ) represent the original probability of selecting vₖ, the index i runs over all eligible tokens for selection and the variable τ is the temperature parameter that can be set. The higher the value of τ, the more equal the modified probabilities for the tokens become among each other. While the lower the value of τ, the more polarizing the modified probabilities for the tokens become relative to the original probabilities, with higher original probabilities becoming higher modified probabilities and lower original probabilities becoming lower modified probabilities. Therefore, the various values of τ in the context of temperature decoding control the probabilistic variability of sampled output sequences, with a value of τ=1.0 not modifying the original token selection probabilities, lower values of τ (e.g., 0.1, 0.2, 0.5, and so on) resulting in sampled output sequences that more often closely align with a ‘highest probability selection procedure’ (i.e., the system selects each token of the output sequence according to the highest probability over the tokens of the vocabulary) and higher values of τ (e.g., 1.1, 1.2, 1.5, 2.0, and so on) resulting in output sequences that more often closely align with a ‘random selection procedure’ (i.e., the system selects each token of the output sequence randomly from among the tokens of the vocabulary).

The system can select one or more of the candidate training reasoning outputs to be included in respective training examples using a variety of methods.

For example, the system can select all candidate reasoning outputs.

As another example, the system can select a random subset of candidate reasoning outputs.

As another example, the system can select candidate reasoning outputs that satisfy a length requirement (e.g., a requirement for number of words, e.g., either a requirement to include less than a certain number of words or a requirement to include more than a certain number of words).

As another example, the system can select candidate reasoning outputs that include specific keywords (e.g., “fun”, “boring”, “cheap”, and so on), or topics (e.g., “Halloween”, “summer vacation”, “Christmas”, and so on).

In some implementations, to select one or more of the candidate training reasoning outputs to be included in respective training examples, the system, for each of the candidate training reasoning outputs, performs the following. The system determines whether the candidate training reasoning output is aligned with a ground truth training reasoning output for the training interaction history for the corresponding user and the training metadata. Then the system selects the candidate training reasoning output to be included in a respective training example only if the candidate training reasoning output is aligned with the ground truth training reasoning output. The ground truth reasoning outputs can be the reasoning outputs included in reasoning examples, e.g., included in reasoning examples 214 generated by the system 200 referenced in FIG. 2 above.

As another example, to select one or more of the candidate training reasoning outputs to be included in respective training examples, the system can select candidate reasoning outputs that align with the ground truth rating of the training content item for the corresponding user. That is, the system can, simultaneously to generating candidate reasoning outputs, generate respective predicted ratings (e.g., using the above example input sequences that include instructions to generate a predicted rating). The system can then select those candidate reasoning outputs with respective predicted ratings that align with the ground truth rating of the training content item for the corresponding user.

Generally, a predicted rating ‘aligns’ with a ground truth rating if the predicted rating and ground truth rating qualitatively or quantitatively match.

For example, alignment can refer to the predicted rating exactly matching the ground truth rating (e.g., a predicted rating of “five” and a ground truth rating of “five”).

As another example, alignment can refer to the binary conversions of the predicted rating and the ground truth rating matching. For example, for a five point scale rating, the binary conversion operator can be one that returns 1 if the operand is greater than 3 and returns 0 otherwise. So, a predicted rating of 5 (i.e., 5>3 is true) and ground truth rating of 4 (i.e., 4>3 is true) results in alignment. While a predicted rating of 5 (i.e., 5>3 is true) and ground truth rating of 3 (i.e., 3>3 is false) does not result in alignment.

As another example, alignment can refer to the predicted rating matching the ground truth rating to within a tolerance. As a particular example, the alignment can refer to absolute value of the difference being equal to or less than one (e.g., for a predicted rating of 5 and a ground truth rating of 3 the absolute value of the difference is greater than one, and therefore, the predicted rating and the ground truth rating are not aligned).

As another example, alignment can refer to the average score of tokens corresponding to the ground truth rating assigned by the language model neural network exceeding a pre-determined threshold after the language model neural network has processed the preceding tokens representing the input sequence and the generated reasoning output.

Generating multiple training examples for the same user interaction history, and metadata of a content item, but different reasoning outputs captures that different personal preferences and reasons of a user can lead to the same rating of a content item. As a result, training the language model to further improve the quality of the reasoning outputs with these training examples improves its performance for generating diverse reasoning outputs and accurate predicted ratings.

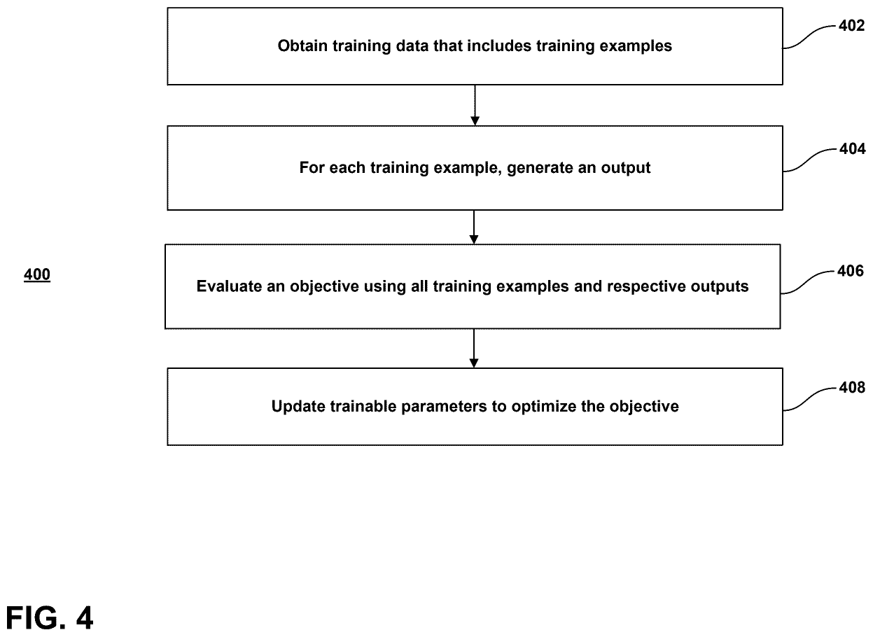

Further details of training the language model neural network are described below with reference to FIG. 4.

In some implementations, after generating the predicted rating for the current content item that is a prediction of a rating provided by the particular user after interacting with the current content item, the system determines whether to recommend the current content item to the particular user using the predicted rating.

For example, the system can determine to recommend the current content item if the predicted rating exceeds a pre-determined threshold, and not to otherwise.

As a particular example, if the predicted rating belongs to a five-point scale, the system can have a pre-determined threshold of three points such that the system will determine to recommend the content item if the predicted rating is above three, but the system will determine not to recommend the content item if the predicted rating is below three.

As another example, the system can process the predicted rating along with other data using a machine learning model neural network that generates a decision of whether to recommend the content item to the user or not.

As a particular example, the system can use a classifier machine learning model neural network to process the predicted rating along with other context data (e.g., user device, time of day, time spent on software application, and so on) that outputs a determination to recommend the content item or not to the user.

Further in some implementations, in response to determining to recommend the current content item to the particular user, the system provides the current content item for presentation to the particular user.

For example, the system can provide the current content item for presentation to the particular user via an end user device (e.g., a smart phone, a tablet, a laptop, and so on). For example, the system can provide the current content item for presentation through a display screen (e.g., smart phone touch screen, tablet screen, or laptop screen) or through audio sound (e.g., smart phone speakers, table speakers, or laptop speakers).

As a particular example, given the context of a particular user using a smart phone to browse video content items on a video sharing platform webpage, the system can receive the interaction history for the particular user and metadata characterizing the current content item from webpage-maintained data. Then, the system can generate a predicted rating (as described above) for a current content item. If the predicted rating exceeds a pre-determined value (e.g., exceeds 3 on a 5-point scale), the system can determine to recommend the video to the user and provide the current content item for presentation (e.g., through presentation of the video on the webpage through the smartphone display).

As another particular example, given the context of a particular user using a laptop to browse e-commerce product content items on an e-commerce store, the system can receive the interaction history for the particular user and metadata characterizing the current content item from e-commerce store. Then, the system can generate a predicted rating (as described above) for a current content item. If the predicted rating exceeds a pre-determined value, the system can determine to recommend the e-commerce product to the user and provide the current content item for presentation (e.g., through presentation of the e-commerce product on a banner of a webpage through the laptop display).

FIG. 4 is a flow diagram of an example process 400 for training a language model neural network to further improve the quality of the reasoning outputs. For convenience, the process 400 will be described as being performed by a system of one or more computers located in one or more locations. For example, a rating prediction system, e.g., the rating prediction system 100 of FIG. 1, appropriately programmed in accordance with this specification, can perform the process 400.

The system trains the language model neural network by repeatedly updating the trainable parameters of the language neural network using a set of training data. That is, the system can repeatedly perform the following described example process using training examples to train the language neural network from scratch, i.e., train from randomly initialized trainable parameters, or further train the language model neural network from pre-trained trainable parameters.

The system obtains training data that includes training examples (step 402). Each training example includes (i) a training interaction history for a corresponding user, (ii) training metadata characterizing a training content item, (iii) a target rating for the training content item, and (iv) a training reasoning output.

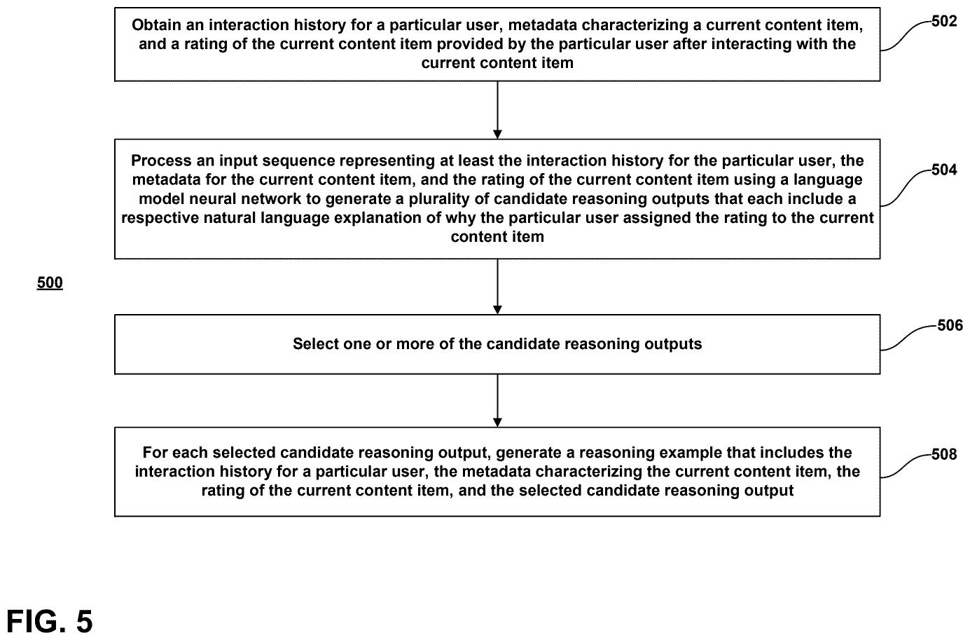

In some cases, the system obtains training data that includes reference reasoning examples (i.e., a data set that includes high quality reference reasoning outputs). Further details of generating reasoning examples are described below in reference to FIG. 5.

As described above, in some cases, the system generates training reasoning outputs by processing an input that includes the training interaction history, and the training metadata using the language model neural network (or sometimes using another language model neural network), and then optionally filters and then selects the training reasoning outputs to generate training examples.

The system, for each training example, generates an output (step 404). In other words, the system, for each training example, processes an input sequence representing at least (i) the training interaction history for the corresponding user and (ii) the training metadata characterizing the training content using the language model neural network to generate a reasoning output and a predicted rating. For example, the system can generate an output sequence of tokens that represents a reasoning output and a predicted rating.

The system evaluates an objective using all training examples and respective outputs (step 406). In particular, the objective generally includes a loss for each training example.

For example, the system, for each output (i.e., reasoning output and predicted rating) —training example pair, computes the loss associated with the difference between the training reasoning output and reasoning output and between the target rating for the training content item and the predicted target rating.

For example, the system can use “teacher forcing” (i.e., using the appropriate preceding token inputs to generate the score for the appropriate next output token, where the appropriate preceding tokens and appropriate next output token are determined by the training reasoning output and target rating) to generate a score for each position of the output sequence. Then the loss can be a sum, for each training example and for each output position, a negative log likelihood computed from the score assigned to the token at the output position by the language model neural network.

The system updates trainable parameters to optimize the objective (step 408). The system updates the trainable parameters of the language model neural network to optimize the objective in any variety of ways, e.g., gradient based method, evolutionary algorithm-based method, Bayesian optimization, grid search, and so on.

For example, the system can optimize the objective by minimizing the loss of one or more training examples described above using any of a variety of gradient descent techniques (e.g., batch gradient descent, stochastic gradient descent, or mini-batch gradient descent) that include the use of a backpropagation technique to estimate the gradient of the loss with respect to trainable parameters and to update the trainable parameters accordingly.

Generally, the system repeats the above steps (404-410) until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

FIG. 5 is a flow diagram of an example process 500 for generating reasoning examples. For convenience, the process 500 will be described as being performed by a system of one or more computers located in one or more locations. For example, a reasoning generation system, e.g., the reasoning generation system 200 of FIG. 2, appropriately programmed in accordance with this specification, can perform the process 500.

The system obtains an interaction history for a particular user, metadata characterizing a current content item, and a rating of the current content item provided by the particular user after interacting with the current content item (step 502).

In some cases, the interaction history for the particular user includes respective historical metadata for each of one or more historical content items that have been interacted with by the particular user. As described above, historical metadata of a historical content item refers to any information (of any type, e.g., text, image(s), audio, video(s), etc.) relevant to describing the historical content item or describing previous user interaction with the historical content item. For example, for a video content item, the historical metadata can include: video view count, title of the video, length of the video, topics included in the video, thumbnail image of the video, and so on.

Further in some cases, the interaction history for the particular user includes, for each of the one or more historical content items, a respective historical rating for the historical content item provided by the particular user after interacting with the historical content item. As described above, historical rating for the historical content item is a score on a defined scale indicating user approval (e.g., a 3 point scale, 5 point scale, 10 point scale, 100 point scale, and so on).

In some cases, the interaction history for the particular user includes, for each of the one or more historical content items, a respective natural language review of the historical content item provided by the particular user after interacting with the historical content item. As described above, the natural language review of the historical content item can be any natural language expression regarding the historical content item (e.g., a multi-paragraph product review of an e-commerce product sold on a website, a comment of a video uploaded to and viewed on a video sharing platform).

The system processes an input sequence representing at least the interaction history for the particular user, the metadata for the current content item, and the rating of the current content item using a language model neural network to generate a plurality of candidate reasoning outputs that each include a respective natural language explanation of why the particular user assigned the rating to the current content item (step 504).

For example, to generate a plurality of candidate reasoning outputs, the system can use the language model neural network to process the input sequence that represents the interaction history, the metadata, and the rating for the user and current content item but also includes natural language instructions to generate multiple different possible reasonings for the given rating. As a particular example of the input sequence, the input sequence can be “Given a user with interaction history <training interaction history> and a rating of <rating> for <metadata>, generate an enumerated list of different but plausible reasonings of why the user assigns that rating.”

As another example, to generate a plurality of candidate reasoning outputs, the system can repeatedly process the input sequence that represents the interaction history, the metadata, and the rating for the user and current content item to generate multiple output sequences (which each include a respective candidate reasoning output). As a particular example, the system can process an input sequence such as “Given a user with interaction history <training interaction history> and a rating of <rating> for <metadata>, generate a plausible reasoning of why the user assigns that rating.” repeatedly to generate multiple output sequences.

As described above, in order for the output sequences (and therefore, reasoning outputs) to be different from each other, the system in some cases, for each output sequence, samples tokens for each output position of the output sequence proportionately to the scores assigned to the tokens of the vocabulary by the language model neural network. As a result, the plurality of output sequences collectively include a plurality of candidate training reasoning outputs. Further in some cases, the system can use decoding temperature parameter to modify the probability of selecting tokens for each output position.

It will be understood that the language model neural network can have similar architectures and uses as the language model neural networks described above, and therefore, can have any of a variety of neural network architectures, including fully connected layers, convolutional layers, recurrent layers, attention-based layers, and so on, as is appropriate.

In some cases, the input sequence includes a natural language description of the interaction history and a natural language description of the metadata for the current content item. For example, for a current content item that is an e-commerce product the input sequence could include the natural language description “Item price” for the interaction history price data of a historical content item that was a previously purchased e-commerce product with a price of “{price}”. Likewise, for the same example current content item, the input sequence could include the natural language description “Brand” for the metadata of the current content item that has a brand of “{brand}”.

In some cases, the input sequence further includes a natural language instruction to explain why the particular user assigned the rating to the current content item.

For example, the input sequence can include instructions for the language model neural network to generate a post hoc explanation (i.e., a candidate reasoning output), describing why the particular user assigned such the rating based on the given particular user interaction history and metadata of the current content item. As a particular example, given the context of an e-commerce content item, the input sequence can be “Given the user's past purchase history <interaction history>, why did the user give a rating of <rating of the current content item> to <metadata for current content item>?”

Note that the candidate reasoning outputs of step 504 are different from the aforementioned candidate training reasoning outputs generated by a rating prediction system, e.g., the rating prediction system 100 of FIG. 1, because to generate the candidate training reasoning outputs the rating prediction system did not include the ground truth rating in the input sequence.

The system selects one or more of the candidate reasoning outputs (step 506).

In some cases, to select one or more of the candidate reasoning outputs, the system, for each candidate reasoning output, processes an input sequence representing at least the interaction history for the particular user, the metadata for the current content item, and the candidate reasoning output using the language model neural network to generate predicted rating for the current content item. Then, the system determines whether the predicted rating for the current content item matches the rating. Lastly, the system selects the candidate reasoning output when the predicted rating for the current content item matches the rating.

For these cases, by validating the predicted rating based on the candidate reasoning outputs against the rating, the system ensures selecting high-quality reasonings.

In some cases, to select one or more of the candidate reasoning outputs, the system, for each candidate reasoning output, determines whether the candidate reasoning output identifies the rating. Then, the system selects the candidate reasoning output when the candidate reasoning output does not identify the rating.

For example, the system can use keyword matching to determine whether the candidate reasoning output identifies the rating and only select the candidate reasoning output when the system determines the candidate reasoning does not identify the rating. As a particular example, the system can use keywords “a rating of”, “stars”, “scores” for keyword matching to determine whether the candidate reasoning output identifies the rating.

In some cases, the system selects the candidate reasoning output as an initial selected candidate reasoning output when the candidate reasoning output does not identify the rating (e.g., as described above). In other words, in some cases, the system performs multiple rounds to select one or more candidate reasoning outputs, and one of these rounds includes selecting candidate reasoning outputs that do not identify the rating (i.e., do not include the rating or keywords such as “rating”/“stars”/“points”/“score” related to the rating).

The system, for each selected candidate reasoning output, generates a reasoning example that includes the interaction history for a particular user, the metadata characterizing the current content item, the rating of the current content item, and the selected candidate reasoning output (step 508).

An example technique for generating reasoning examples that includes aspects of steps 502-508 is shown in Table 1.

TABLE 1
Algorithm 1 Reference generation with self-verification

| 1: | Inputs: N | |
|---|---|---|
| 2: | [symbol] ← ∅ | [symbol] verified references |

| | |
|---|---|
| 3: | for ( [symbol] ᵤ, Mᵢ, r_{u,i}) in dataset do |
| 4: | for n = 1 . . . N do |
| 5: | ĝ_{u,i}ⁿ ← LLM( [symbol] ᵤ, [symbol] ᵢ, r_{u,i}) |
| 6: | ĝ_{u,i}ⁿ ← post-process(g_{u,i}ⁿ) |
| 7: | \tilde{r}_{u,i}ⁿ ← LLM( [symbol] ᵤ, [symbol] ᵢ, ĝ_{u,i}ⁿ) |
| 8: | if r_{u,i}ⁿ = r_{u,i} then |
| 9: | [symbol] ← [symbol] ∪ {ĝ_{u,i}ⁿ} |
| 10: | end if |
| 11: | end for |
| 12: | end for |

In particular, [symbol] represents the set of selected candidate reasoning outputs; [symbol] ᵤ refers to a particular user u interaction history; r_{u,i} refers to the rating of the current content item i by user u; [symbol] ᵢ refers to metadata characterizing a current content item; LLM(·) refers to a language model neural network; N refers to the number of candidate reasoning outputs w generate;

$${\hat{g}}_{u , i}^{n}$$

refers the n^{th} generated candidate reasoning output for the particular user u and current content item i; and

$${\tilde{r}}_{u , i}^{n}$$

represents the predicted rating for the current content item.

The described technique of algorithm 1 of Table 1 above selects candidate reasoning outputs that are useful in predicting a rating for a content item by a user. For example, by selecting candidate reasoning output

$${\hat{g}}_{u , i}^{{n}_{i}}$$

when the predicted rating for the current content item matches the rating

$$( i . e . , if {\tilde{r}}_{u , i}^{n} = {r}_{u , i}^{n} ) .$$

In some cases, after the system generates reasoning examples, the system evaluates reasoning outputs generated by another neural network using a data set that includes the reasoning examples for the selected candidate reasoning outputs.

For example, the system can evaluate the reasoning outputs generated by another neural network using quantitative metrics that require “reference” reasoning outputs (i.e., one or more reasoning outputs that are used to assess the quality of the one or more reasoning outputs generated by another neural network).

Some examples of these quantitative metrics are ROUGE-1 F1, METEOR, BLEU, and BERT Score. The metrics BLEU and ROUGE-1 measure syntactic similarity by computing the exact n-gram overlap between the generated reasoning output and the reference reasoning outputs. On the other hand, METEOR and BERT Score consider semantic similarity, providing a more comprehensive evaluation by incorporating contextual information.

A “reference set of reasonings” is essential for calculating these metrics, but, before its generation has been a challenge due to the subjective nature of the reasoning for rating prediction. Therefore, this described technique to generate reasoning examples valuable because it enables the calculation of metrics that otherwise cannot be done.

In some cases, after the system generates reasoning examples, the system trains another neural network on a data set that includes the reasoning examples for the selected candidate reasoning outputs (e.g., example process 400 described above to train a language model neural network to generate improved reasoning outputs).

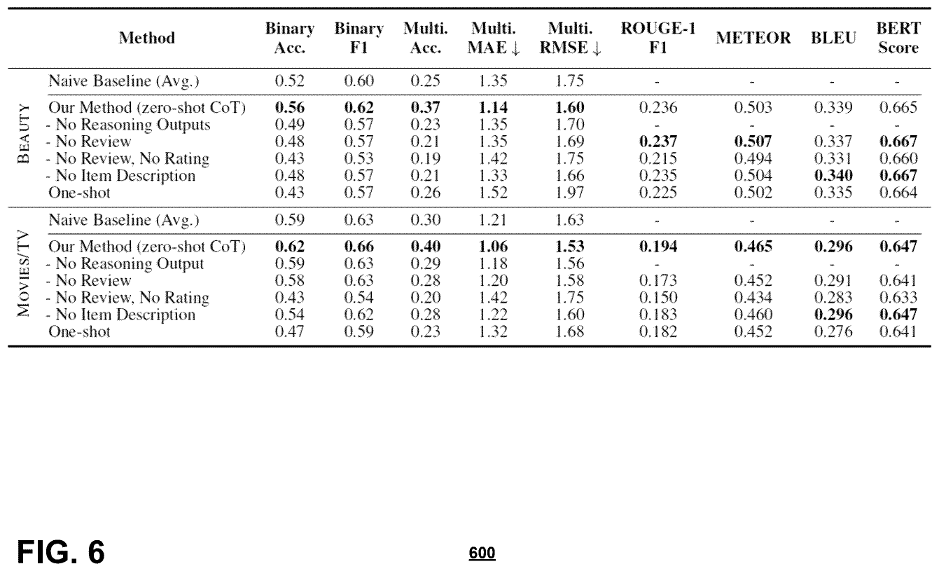

FIG. 6 is an example 600 of the performance of the described techniques.

In particular, example 600 shows a table that summarizes the performance of a rating prediction system (in terms of generating a predicted rating for a current content item and a reasoning output that includes a natural language explanation of the predicted rating) of the described techniques, of the described techniques with particular missing aspects, and other techniques.

For the table, the rating of content items belongs to a five point scale and the content items belong to two content item domains, i.e., e-commerce products (i.e., BEAUTY products for sale, e.g., make-up) and videos (i.e., MOVIE/TV shows for).

The column labeled “Method” lists the described techniques as “Our Method (zero-shot CoT)” followed by the described techniques with particular missing aspects, which are “-No Reasoning Output” (i.e., the system does not generate a reasoning output), “-No Review” (i.e., the interaction history does not include natural language reviews or historical ratings for historical content items), “-No Review, No Rating” (i.e., the interaction history does not include natural language reviews of historical content items or rating), “No Item Description” (i.e., the system does not process metadata of the current content item). The column also lists the conventional techniques of “one shot” (i.e., the system does not fine-tune the language model and processes a single example of interaction history, metadata of a content item, and rating of the content item before generating a rating for the current content item) and “Naïve Baseline (Avg.)” (i.e., using historical rating average of the user's history as a prediction for the current item).

The columns “Binary Acc.” And “Binary F1” refer to the performance of the predicted ratings but in terms of a further processing of the predicted rating to be 1 if the predicted rating exceeds 3 and 0 otherwise (with a similar transformation for the ground truth rating of the content item). The column “Binary Acc.” refers to the average rate of the predicted rating correctly matching (1 or 0) the ground truth rating of a current content item. The column “Binary F1” refers to the F1 score of the predicted ratings.

The columns “Multi. Acc.”, “Multi MAE.” and “Multi RMSE” refer to the performance of the predicted ratings on its original 5-point scale. The column labeled “Multi. Acc.” refers to the average rate the predicted rating correctly matches the ground truth rating (1, 2, 3, 4, or 5) of a current content item. The column labeled “Multi MAE” refers to the mean absolute error and the column labeled “Multi RMSE” refers to the root-mean squared error of the predicted rating vs the ground truth rating.

The columns “ROUGE-1 F1”, “METEOR”, “BLEU”, and “BERT Score” refer to evaluates the quality of the reasoning output (when generated) using a reference set (as described above).

The table of example 600 shows a notable performance improvement across both content item domains for techniques that include the language model neural network outputting reasoning alongside the predicted rating (i.e., the described techniques (“zero-shot CoT”) vs. “No Reasoning Outputs”). This suggests that personalized tasks are inherently difficult for language model neural networks to solve without further guidance such as engaging in an intermediate reasoning step.

The table of example 600 also shows a significant performance drop when the historical reviews are excluded from the interaction history (“No Review”). The performance declines further when both reviews and ratings (i.e., historical rating) are excluded from the interaction history (“No Review, No Rating”). This indicates that historical review in interaction history is essential for utilizing the reasoning capabilities of language models. Without user reviews, the language model lacks detailed insights into past user interactions and can only rely on numerical ratings, resulting in performance of the technique similar to or worse than “No Reasoning Outputs” and the naïve average baseline.

Generally, the table of example 600 shows that including all aspects of the described techniques results in the best performance across all metrics that measure the performance predicted ratings (i.e., Binary Acc. Binary F1, Multi Acc., Multi MAE, Multi RMSE).

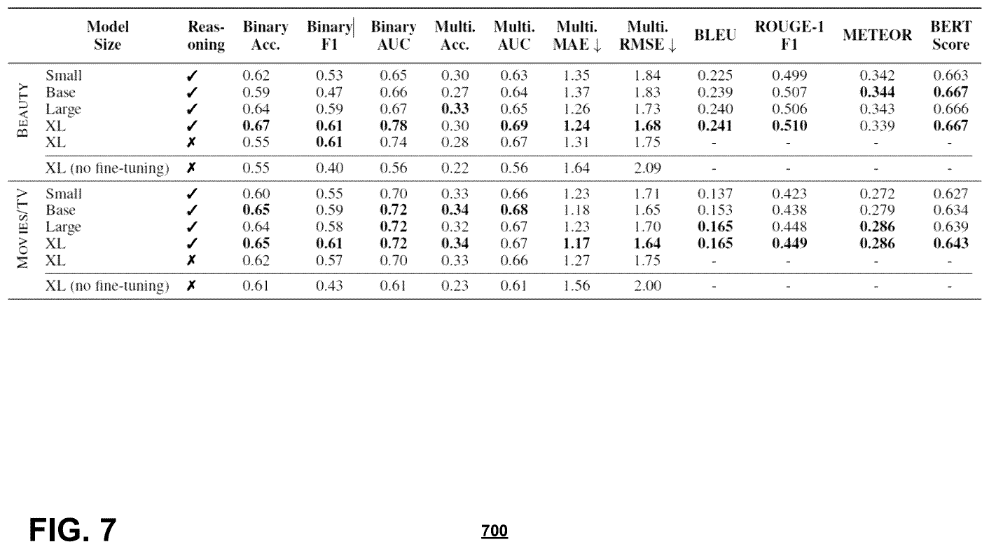

FIG. 7 is an example 700 of the performance of the described techniques.

In particular, example 700 shows a table that summarizes how fine-tuning (training) a (smaller) language model neural network of a rating prediction system using selected training reasoning outputs of another (larger) language model neural network for (smaller) language model neural networks of various sizes.

The common column and row labels between this table the table included in example 600 above have identical definitions. In addition, the rows labeled Small, Base, Large, and XL indicate the sizing of the language model in order of smallest to largest. The other (larger) language model that generates the reasoning outputs the system uses to train the (smaller) language model has the size XL. The row “XL (no fine-tuning)” is a baseline technique that does not train the language model neural network using training reasoning outputs. The column labeled “Reasoning” indicates if the language model neural network generates reasoning outputs when generating predicted rating for a current content item.

Additionally, without fine-tuning the language model neural network was unable to follow instructions with reasoning, and therefore the table does not include XL with Reasoning as an entry.

Generally, the table of example 700 shows that the aspect of fine-tuning the language model neural network using training reasoning outputs of another language model of the described techniques improves the performance of predicted ratings. In fact, without fine-tuning the language model neural network cannot generate a predicted rating with reasoning (as described above).

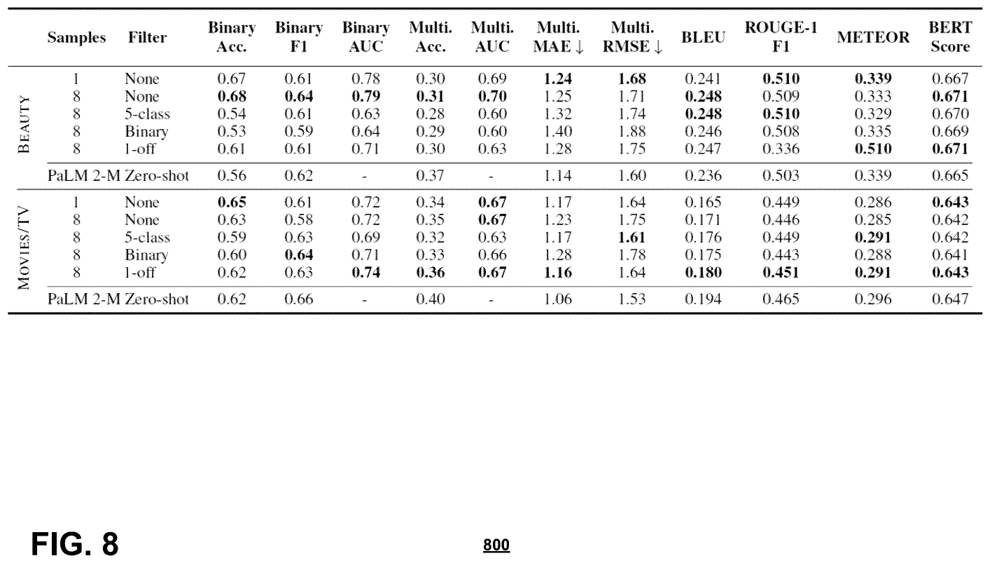

FIG. 8 is an example 800 of the performance of the described techniques.

In particular, example 800 shows a table that summarizes the performance of the described techniques for variations of generating and selecting one or more of the candidate training reasoning outputs to be included in respective training examples to fine tune the language model neural network of a rating prediction system.

The common column and row labels between this table the tables included in example 600 and example 700 above have identical definitions. In addition, the column “samples” refers to how many candidate training reasoning outputs to generate for a given set of training interaction history for a corresponding user and training metadata characterizing a training content item (i.e., generating 1 or 8 candidate training reasoning outputs). The column “filter” refers to conditions that constitute alignment when the system selects candidate reasoning outputs that align with the ground truth rating of the training content item for the corresponding user. The filters are None (i.e., all generated candidate training reasoning outputs are selected), 5-class (i.e., candidate training reasoning outputs are only selected for when a generated predicted rating generated by processing the training reasoning output matches the ground truth rating), binary (i.e., candidate training reasoning outputs are only selected for when a binary conversion of generated predicted rating generated by processing the training reasoning output matches the binary conversion of the ground truth rating) and 1-off (i.e., candidate training reasoning outputs are only selected for when a generated predicted rating generated by processing the training reasoning output differs from the ground truth rating by no more than one point).

In the BEAUTY domain, fine-tuning with samples=8 without any filtering slightly outperforms finetuning with only samples=1. Surprisingly, applying filtering methods significantly diminishes performance on the rating task. But this is due to the filtering, in this case, removing a substantial portion of candidate training reasoning output, leading to poorer performance. This is particularly evident when the “5-class” filter, the most stringent filter, is applied. Conversely, in the MOVIES/TV domain, the best results are achieved with the “1-off” filtering method. We attribute this to the language model neural network strong pretrained knowledge in the MOVIES/TV domain, allowing it to tolerate the removal of examples where the reasoning does not align with the ground truth rating. In contrast, the BEAUTY domain may require more training examples of user transaction history and user-item relations for effective learning. Removing candidate training reasoning outputs, even those with misaligned reasoning, may inadvertently reduce domain information, resulting in diminished performance.

In conclusion, the table of example 800 shows that the aspect of generating multiple candidate reasoning outputs to include in training examples (i.e., Samples=8) and selecting the candidate reasoning outputs to include in training examples (i.e., Filter=“1-off”) perform best.

Further to the descriptions above, a user may be provided with controls allowing the user to make an election as to both if and when systems, programs, or features described herein may enable collection or use of user information (e.g., collection or use of user's interaction history; or collection or use of user historical interaction history and historical rating), and if the user is sent content or communications from a server (e.g., recommended content item or presentation of a recommended content item). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining an interaction history for a particular user;
obtaining metadata characterizing a current content item;
processing an input sequence representing at least the interaction history for the particular user and the metadata for the current content item using a language model neural network to generate (i) a predicted rating for the current content item that is a prediction of a rating provided by the particular user after interacting with the current content item and (ii) a reasoning output that comprises a natural language explanation of the predicted rating given the interaction history and the metadata.

2. The method of claim 1, wherein the interaction history for the particular user comprises respective historical metadata for each of one or more historical content items that have been interacted with by the particular user.

3. The method of claim 2, wherein the interaction history for the particular user comprises, for each of the one or more historical content items, a respective historical rating for the historical content item provided by the particular user after interacting with the historical content item.

4. The method of claim 2, wherein the interaction history for the particular user comprises, for each of the one or more historical content items, a respective natural language review of the historical content item provided by the particular user after interacting with the historical content item.

5. The method of claim 1, wherein the input sequence comprises a natural language description of the interaction history and a natural language description of the metadata for the current content item.

6. The method of claim 1, wherein the input sequence further comprises a zero-shot prompt.

7. The method of claim 6, wherein the zero-shot prompt comprises a natural language task description that comprises a natural language instruction to generate the predicted rating and the reasoning output.

8. The method of claim 1, wherein the language model neural network has been trained on training data that comprises a plurality of training examples, each training example comprising (i) a training interaction history for a corresponding user, (ii) training metadata characterizing a training content item, (iii) a target rating for the training content item, and (iv) a training reasoning output.

9. The method of claim 8, wherein the language model neural network has been pre-trained prior being trained on the training data.

10. The method of claim 8, wherein the training reasoning output in each of the training examples has been generated using another language model neural network.

11. The method of claim 10, wherein the other language model neural network is a larger neural network than the language model neural network.

12. The method of any one of claim 10, wherein, for each training example, generating the training reasoning output comprises:
processing an input sequence representing at least (i) the training interaction history for the corresponding user and (ii) the training metadata characterizing a training content item using the other language model neural network to generate a plurality of candidate training reasoning outputs; and
selecting one or more of the candidate training reasoning outputs to be included in respective training examples.

13. The method of claim 12, wherein selecting one or more of the candidate training reasoning outputs to be included in respective training examples comprises:
for each of the candidate training reasoning outputs:
determining whether the candidate training reasoning output is aligned with a ground truth training reasoning output for the training interaction history for the corresponding user and the training metadata; and
selecting the candidate training reasoning output to be included in a respective training example only if the candidate training reasoning output is aligned with the ground truth training reasoning output.

14. The method of claim 1, further comprising:
determining whether to recommend the current content item to the particular user using the predicted rating.

15. The method of claim 14, further comprising:
in response to determining to recommend the current content item to the particular user, providing the current content item for presentation to the particular user.

16. A method performed by one or more computers, the method comprising:
obtaining an interaction history for a particular user, metadata characterizing a current content item, and a rating of the current content item provided by the particular user after interacting with the current content item;
processing an input sequence representing at least the interaction history for the particular user, the metadata for the current content item, and the rating of the current content item using a language model neural network to generate a plurality of candidate reasoning outputs that each comprise a respective natural language explanation of why the particular user assigned the rating to the current content item;
selecting one or more of the candidate reasoning outputs; and
for each selected candidate reasoning output, generating a reasoning example that includes the interaction history for a particular user, the metadata characterizing the current content item, the rating of the current content item, and the selected candidate reasoning output.

17. The method of claim 16, further comprising:
evaluating reasoning outputs generated by another neural network using a data set that includes the reasoning examples for the selected candidate reasoning outputs.

18. The method of claim 16, further comprising:
training another neural network on a data set that includes the reasoning examples for the selected candidate reasoning outputs.

19. The method of claim 16, wherein selecting one or more of the candidate reasoning outputs comprises, for each candidate reasoning output:
processing an input sequence representing at least the interaction history for the particular user, the metadata for the current content item, and the candidate reasoning output using the language model neural network to generate predicted rating for the current content item;
determining whether the predicted rating for the current content item matches the rating; and
selecting the candidate reasoning output when the predicted rating for the current content item matches the rating.

20. The method of claim 16, wherein the interaction history for the particular user comprises respective historical metadata for each of one or more historical content items that have been interacted with by the particular user.

21. The method of claim 20, wherein the interaction history for the particular user comprises, for each of the one or more historical content items, a respective historical rating for the historical content item provided by the particular user after interacting with the historical content item.

22. The method of claim 20, wherein the interaction history for the particular user comprises, for each of the one or more historical content items, a respective natural language review of the historical content item provided by the particular user after interacting with the historical content item.

23. The method of claim 16, wherein the input sequence comprises a natural language description of the interaction history and a natural language description of the metadata for the current content item.

24. The method of claim 16, wherein the input further comprises a natural language instruction to explain why the particular user assigned the rating to the current content item.

25. The method of claim 16, wherein selecting one or more of the candidate reasoning outputs comprises, for each candidate reasoning output:
determining whether the candidate reasoning output identifies the rating; and
selecting the candidate reasoning output when the candidate reasoning output does not identify the rating.

26. A system comprising one or more computers and one or more storage devices storing instructions that when executed by the one or more computers cause the one more computers to perform operations, the operations comprising:
obtaining an interaction history for a particular user;
obtaining metadata characterizing a current content item;
processing an input sequence representing at least the interaction history for the particular user and the metadata for the current content item using a language model neural network to generate (i) a predicted rating for the current content item that is a prediction of a rating provided by the particular user after interacting with the current content item and (ii) a reasoning output that comprises a natural language explanation of the predicted rating given the interaction history and the metadata.
